(19) United States
(12) Patent Application Publication
(10) Pub. No.: US 2026/0234061 A1
(43) Pub. Date: Aug. 13, 2026

(54) DUST-FREE INSULATION MATERIAL AND METHOD FOR PRODUCING SAME

(71) Applicant: JOONG-IL MATERIALS INC., Incheon (KR)

(72) Inventors: Tae Jung LEE, Seoul (KR); Chang Dae OH, Incheon (KR); Byung Gwan GWAK, Incheon (KR)

(21) Appl. No.: 19/156,802

(22) PCT Filed: Feb. 15, 2024
(86) PCT No.: PCT/KR2024/095227

§ 371 Date: Aug. 14, 2025

(30) Foreign Application Priority Data
Apr. 11, 2023 (KR) 10-2023-0047607

(51) Int. Cl. C04B 35/14; C04B 35/622; C04B 35/64

(52) U.S. Cl. CPC C04B 35/14; C04B 35/62222; C04B 35/64; C04B 2235/3217; C04B 2235/3418; C04B 2235/5445; C04B 2235/5454

(57) ABSTRACT

The present disclosure relates to a dust-free insulating material. The dust-free insulating material coating solution is provided for application to an insulating material comprising silica and alumina. The coating solution comprises 51.4 to 62.9% by weight of a silica sol, 12.9 to 15.7% by weight of an alumina sol, and the balance being a solvent.

### CROSS-REFERENCE TO RELATED APPLICATIONS

This application is the National Stage filing under 35 U.S.C. 371 of International Application No. PCT/KR2024/095227, filed on Feb. 15, 2024, which claims the benefit of Korean Patent Application No. 10-2023-0047607, filed on Apr. 11, 2023, the contents of which are all hereby incorporated by reference herein in their entirety.

### TECHNICAL FIELD

The present disclosure relates to a dust-free insulating material, and more specifically, to a dust-free insulating material that does not generate dust and thus can be applied inside a combustion chamber, and a method for manufacturing the same.

### Background Art

Recently, each country and company is making great efforts to respond to environmental pollution and global warming. In particular, since fossil fuels are currently the most widely used energy source, but they have a great impact on environmental pollution and global warming, much effort is being made to secure alternative energy to replace them. In particular, in order to obtain hydrogen, a promising alternative energy source, technologies related to reforming reactions of various gases using catalysts are in the spotlight. Representative examples include reactions that convert fossil fuels such as methane, methanol, gasoline, and natural gas into hydrogen, and include steam reforming reactions, partial oxidation reactions, and autothermal reforming reactions.

These reforming reactions inevitably use catalysts, and catalytic reactions produce reactants through endothermic or exothermic reactions depending on fuel conditions.

In the case of an endothermic reaction, a method is applied in which a catalytic reactor is installed inside a combustion chamber and a burner installed inside the combustion chamber is used to supply a heat source to the catalytic reactor.

In the case of an exothermic reaction, a heat source is required at the initial stage of the catalytic reaction inside the reactor, and after that, the temperature can be controlled due to the exothermic reaction, and the heat according to the reaction temperature is transferred to the outside of the catalytic reactor.

Accordingly, the temperature of the combustion chamber rises high, and an insulating material is applied to the combustion chamber to prevent the temperature inside the combustion chamber from being transferred to the outside of the combustion chamber and to maintain the temperature of the combustion chamber constant.

For example, an insulating material may be mounted on the outer portion of the combustion chamber, but at this time, the combustion chamber directly exposed to heat has a disadvantage in that it must be manufactured with expensive metal materials that can withstand high temperatures.

In addition, if an insulating material is mounted on the inner portion of the combustion chamber, the combustion chamber can be manufactured with inexpensive metal materials by replacing expensive metals in the combustion chamber that is not directly exposed to heat, but an insulating material that does not generate dust must be applied so that dust generated from the insulating material is not mixed with the exhaust gas generated in the combustion chamber. Accordingly, in order to improve the cost of manufacturing the reactor, it is urgent to develop a method for manufacturing an insulating material that does not generate dust and a dust-free insulating material.

### Disclosure

### Technical Problem

In order to solve the problems as described above, an object of the present disclosure is to provide an insulating material that does not generate dust and a method for manufacturing the same.

### Technical Solution

The present disclosure provides a dust-free insulating material coating solution for manufacturing a dust-free insulating material, which is coated on an insulating material containing silica and alumina, and includes: 51.4 to 62.9% by weight of a silica sol; 12.9 to 15.7% by weight of an alumina sol; and a balance of a solvent, wherein water is applied as the solvent so that environmental problems and safety problems can be prevented during the manufacture of a dust-free insulating material, and an increase in drying and firing time required to completely remove organic solvents and organic materials can be prevented.

Furthermore, the present disclosure provides a method for manufacturing a dust-free insulating material, including: an insulating material coating step of manufacturing a coated insulating material by including an insulating material preparation step of preparing an insulating material containing silica and alumina, an impregnation step of impregnating the insulating material with a dust-free insulating material coating solution, and a drying step of drying the insulating material after completion of the impregnation step of the insulating material; a firing step of heating and firing the coated insulating material; a first polishing step of polishing the surface of the coated insulating material with a first polishing paper; and a second polishing step of polishing the surface of the coated insulating material that has undergone the first polishing step with a second polishing paper.

### Advantageous Effects

According to one embodiment of the present disclosure, it is possible to manufacture an insulating material that is stable at high temperatures and does not generate dust, which can be applied inside a combustion chamber.

### DESCRIPTION OF DRAWINGS

FIG. 1 is a schematic diagram of a method for manufacturing a dust-free insulating material according to one embodiment of the present disclosure.

FIG. 2 shows a dust generation test of Example 1 according to one embodiment of the present disclosure and an uncoated insulating material.

FIG. 3 shows a dust generation test of Example 1 and Comparative Examples 1 to 3 according to one embodiment of the present disclosure.

### MODE FOR DISCLOSURE

Hereinafter, embodiments of the present disclosure will be described in detail. However, the present disclosure is not limited to the embodiments disclosed below, but can be implemented in various different forms, and the present embodiments are provided only to make the disclosure of the present disclosure complete and to more completely inform those skilled in the art of the contents of the present disclosure.

The present disclosure, which is for providing a dust-free insulating material, provides a dust-free insulating material coating solution for coating the insulating material so that dust is not generated on the surface of the insulating material, and provides a method for manufacturing the dust-free insulating material to which the insulating material is applied using the dust-free insulating material coating solution. Accordingly, the dust-free insulating material is provided by using the dust-free insulating material coating solution and the manufacturing method to prevent dust from being generated from the insulating material due to low density and low mechanical strength. Accordingly, the dust-free insulating material can be applied to the inside of a combustion chamber.

It is preferable that an insulating material which has a large surface area and low thermal conductivity, is physically/chemically stable, is manufactured from a safe material, is easy to process, and is low in unit price is applied as the insulating material. For example, an insulating material which is applied with silica having excellent thermal stability and alumina having excellent strength is preferably applied as the insulating material, and an insulating material which is formed of 46 to 85% by weight of Al₂O₃, 25 to 54% by weight of SiO₂, and has a density of 350±35 kg/m³ may be applied as the insulating material, but the present disclosure is not limited thereto.

Hereinafter, a dust-free insulating material coating solution for manufacturing the dust-free insulating material of the present disclosure will be described in detail.

The dust-free insulating material coating solution according to the present disclosure includes a silica sol, an alumina sol, and a solvent.

The dust-free insulating material coating solution can improve the mechanical strength and durability of the outside of the insulating material by densifying some of the surface pores of the insulating material.

The dust-free insulating material coating solution may contain 51.4 to 62.9% by weight of a silica sol, 12.9 to 15.7% by weight of an alumina sol, and a balance of a solvent. Accordingly, since the insulating material, in which Al₂O₃ and SiO₂ are the main components, and the dust-free insulating material coating solution have the same components, the dust-free insulating material coating solution may be well coated on the surface of the insulating material.

For example, the silica sol may be a dispersion in which SiO₂ particles are dispersed at a content of 27 to 33% by weight, and a silica sol having a size of the SiO₂ particles of 8 to 25 nm may be applied.

In addition, the alumina sol is a dispersion in which Al₂O₃ particles are dispersed at a content of 5 to 20% by weight, and an alumina sol having a size of the Al₂O₃ particles of 15 to 170 nm may be applied.

In addition, water may be applied as the solvent. For example, distilled water and DI-water may be applied, but the present disclosure is not limited thereto.

Accordingly, a silica sol and an alumina sol, which are hydrophilic substances, are applied so that it is possible to prepare a dust-free insulating material coating solution even in an environment that does not use an organic solvent, and environmental and safety problems that may occur when using an organic solvent can be prevented, and an increase in drying and firing time required to completely remove the organic solvent can be prevented.

In addition, since a silica sol and an alumina sol are applied at a time to the dust-free insulating material coating solution so that a double coating effect of two materials can be obtained with a single coating, manufacturing easiness and economic feasibility can be secured.

In the dust-free insulating material coating solution, if the silica sol ratio is lowered and the alumina sol ratio is increased, dust may be generated on the insulating material, and the insulation effect may be deteriorated. For example, if the dust-free insulating material coating solution contains the silica sol in an amount of less than 51.4% by weight and the alumina sol in an amount of more than 15.7% by weight, when the silica sol is coated on the surface of the insulating material, the ability to densify some of the surface pores of the insulating material may be reduced, the mechanical strength and durability of the outer side of the coated insulating material may be adversely affected, and the dust generation prevention power may be reduced. In addition, the alumina sol ratio may be increased, thereby decreasing the insulation effect.

In addition, in the dust-free insulating material coating solution, if the silica sol ratio and the alumina sol ratio are low and the solvent ratio is high, the strength of the coated insulating material may decrease. For example, if the dust-free insulating material coating solution contains a silica sol in an amount of less than 51.4% by weight and an alumina sol in an amount of less than 12.9% by weight, the silica sol and the alumina sol may not be sufficiently coated on the surface of the insulating material, which may adversely affect the mechanical strength and durability of the outer side of the coated insulating material, and the dust generation prevention power may decrease.

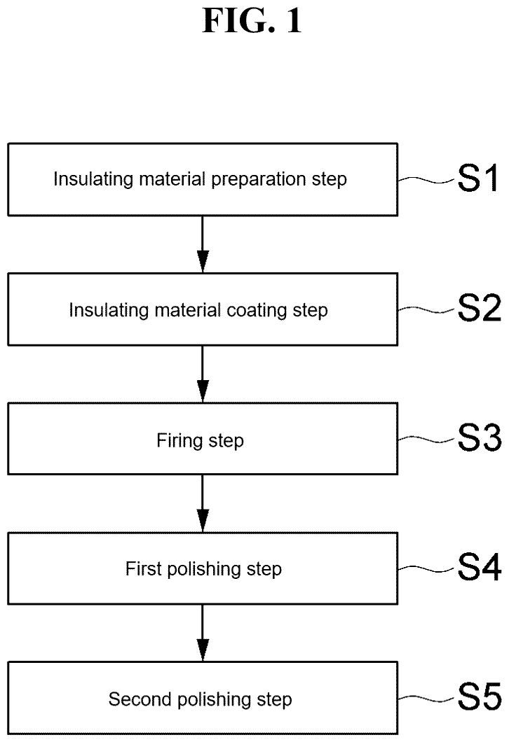

FIG. 1 is a schematic diagram of a method for manufacturing a dust-free insulating material according to one embodiment of the present disclosure.

Referring to FIG. 1, the method for manufacturing a dust-free insulating material includes an insulating material preparation step (S1), an insulating material coating step (S2), a firing step (S3), a first polishing step (S4), and a second polishing step (S5).

The insulating material preparation step (S1) is a step of preparing an insulating material containing silica and alumina. For example, it is a step of preparing an insulating material to be injected into the insulating material coating step (S2).

The insulating material preparation step (S1) may include a step of processing the insulating material before completion of processing into various shapes. At this time, the insulating material can be processed so that it can be mounted on the inner portion of the combustion chamber.

The insulating material preparation step (S1) may include a foreign material removal step of removing foreign materials attached to the surface of the insulating material. For example, dust generated during processing of the insulating material or foreign materials attached during handling of the insulating material may be removed using various methods such as a brush, a blower, or the like. Accordingly, when coating the insulating material with the dust-free insulating material coating solution, it is possible to prevent uneven coating areas or uncoated areas from being formed due to foreign materials attached to the surface of the insulating material, and to prevent dust generation due to foreign materials.

The insulating material coating step (S2) is a step of manufacturing a coated insulating material coated with the dust-free insulating material coating solution, and may include an impregnation step and a drying step.

The impregnation step of the insulating material coating step (S2) is a step of impregnating the insulating material with the dust-free insulating material coating solution.

In the impregnation step, it is preferable that the dust-free insulating material coating solution and the insulating material are prepared at a volume ratio of 1.2 to 1.5:1 to impregnate the insulating material with the dust-free insulating material coating solution. For example, when the dust-free insulating material coating solution ratio is less than 1.2, the insulating material surface may be coated in an amount the required amount or less. In addition, when the dust-free insulating material coating solution ratio exceeds 1.5, waste of the dust-free insulating material coating solution may occur.

The drying step of the insulating material coating step (S2) is a step of drying the insulating material after the impregnation step is completed. For example, hot air drying, infrared drying, and a combination thereof may be applied, but the present disclosure is not limited thereto.

In addition, it is preferable that the insulating material is dried so that it does not overlap each other so that the insulating material can be evenly dried. Accordingly, in the drying step, SiO₂ and Al₂O₃ that were embedded in the insulating material together with the solvent are attached to the surface and surface pores of the insulating material to form a coating layer, and the solvent may be removed.

The drying step is preferably performed at a drying temperature of 180 to 220° C. for 0.5 to 1.5 hours. For example, if the drying temperature is less than 180° C., sufficient heat is not applied, so the drying time becomes long, which may decrease the process efficiency and economic feasibility. In addition, if the drying temperature exceeds 220° C., sufficient heat or more is applied to form a coating layer on the surface of the insulating material by the dust-free insulating material coating solution, which may decrease the process efficiency due to unnecessary energy use.

In addition, if the drying time is less than 0.5 hours, the coating layer by the dust-free insulating material coating solution may not be stably formed on the surface of the insulating material, and if the drying time exceeds 1.5 hours, after the coating layer by the dust-free insulating material coating solution is sufficiently formed on the surface of the insulating material, a decrease in the process efficiency due to unnecessary energy use may occur.

The impregnation step and the drying step of the insulating material coating step (S2) may be repeated at least once. For example, the impregnation step and the drying step of the insulating material coating step (S2) may be repeated one or more times until the coating amount calculated by calculating the density difference based on the weight difference between the coated insulating material that completed the insulating material coating step (S2) and the insulating material before being introduced into the insulating material coating step (S2) becomes 150 to 300 kg/m³ (0.15 to 0.30 g/cm³). At this time, in the insulating material coating step (S2), the dust-free insulating material coating solution penetrates into the pores of the insulating material and is coated, so the change in volume can be ignored when calculating the density. Accordingly, the coated insulating material can be effectively produced through the insulating material coating step (S2).

The firing step (S3) is a step of heating and firing the coated insulating material.

The firing step (S3) is a step of heating and firing the coated insulating material that has completed the insulating material coating step (S2). For example, the firing step (S3) may have various heating furnaces to which hot air heating, infrared heating, and a combination thereof are applied applied thereto, but the present disclosure is not limited thereto. At this time, the heating condition is preferably to raise the temperature to a target temperature which is the combustion chamber internal temperature+50° C., for example, 800 to 1,200° C., at a temperature raising rate of 5 to 10° C./min, and then maintain the temperature for 6 to 12 hours.

The firing step (S3) may form a coating layer on the surface of the coated insulating material from which both the solvent and organic materials are removed while raising the temperature to the target temperature. In addition, it is a process of pre-shrinking the coated insulating material including pores and treating the coated insulating material so that the dust-free insulating material manufactured through a subsequent process does not shrink when applied to the combustion chamber.

For example, if the target temperature of the firing step (S3) is less than 800° C., it may be lower than the temperature of the combustion chamber to which the dust-free insulating material manufactured from the coated insulating material is applied. Accordingly, additional shrinkage may occur when the dust-free insulating material is used in the combustion chamber, which may lower the insulation efficiency of the combustion chamber.

In addition, if the target temperature of the firing step (S3) exceeds 1200° C., it is a temperature sufficiently higher than the reaction temperature of the combustion chamber to which the dust-free insulating material manufactured from the coated insulating material is applied. Accordingly, a decrease in process efficiency may occur due to unnecessary energy use.

In addition, if the temperature raising rate is less than 5° C./min, since it may take an excessive time to reach the target temperature, a decrease in process efficiency may occur, and if the temperature raising rate exceeds 10° C./min, deformation of the coated insulating material may occur due to rapid temperature increase.

The firing step (S3) may not fully perform firing if the operation is performed for less than 6 hours after reaching the target temperature, and if the operation is performed for more than 12 hours, a decrease in the process efficiency may occur due to unnecessary energy and time consumption after the firing is fully performed.

The first polishing step (S4) is a step of polishing the surface of the coated insulating material with the first polishing paper.

The first polishing step (S4) may be performed by polishing the surface of the coated insulating material at a speed of 300 to 500 rpm for 5 to 10 seconds per surface using a polishing machine to which a first polishing paper of #800 to #1000 is applied, thereby enabling surface irregularities and dust to be removed. At this time, a polishing paper to which aluminum oxide, zirconium silicate, ceramic particles, etc. are applied may be applied as the first polishing paper, but the present disclosure is not limited thereto, and a circular or square polishing machine type may be applied as the polishing machine, but the present disclosure is not limited thereto.

For example, if a first polishing paper of less than #800 is used, the coated surface may be excessively cut, which may reduce the effect of preventing dust generation. In addition, if a first polishing paper exceeding #1000 is used, the effect of polishing the micro-irregularities of the surface may be reduced, so the polishing may not be completed within the working time and may take excessive time.

The first polishing step (S4) may include a step of removing dust after polishing the surface of the coated insulating material or foreign materials attached when handling the insulating material using various methods such as a brush, a blower, or the like.

The second polishing step (S5) is a step of polishing the surface of the coated insulating material that has completed the first polishing step with a second polishing paper to manufacture a dust-free insulating material.

The second polishing step (S5) may remove surface irregularities and dust by performing polishing at a speed of 300 to 500 rpm for 5 to 10 seconds per surface of the coated insulating material using a polishing machine to which a #3000 second polishing paper is applied. At this time, a sponge polishing paper type may be applied as the second polishing paper, but the present disclosure is not limited thereto, and a circular or square polishing machine type may be applied as the polishing machine, but the present disclosure is not limited thereto.

In the second polishing step (S5), if a second polishing paper of less than #3000 is used, the surface may be excessively cut, which may reduce the effect of preventing dust generation. In addition, if a second polishing paper exceeding #3000 is used, the effect in polishing the micro-irregularities of the surface may be reduced, so polishing may not be completed within the working time and may take excessive time.

The second polishing step (S5) may include a step of removing dust after polishing the surface of the coated insulating material or foreign materials attached when handling the coated insulating material using various methods such as a brush, a blower, or the like.

Hereinafter, the present disclosure will be described in more detail through Examples, Comparative Examples, and Experimental Examples. However, the following Examples are only intended to help understand the present disclosure, and the scope of the present disclosure is not limited to these Examples in any way.

### Examples 1 to 3

Insulating material: Using an insulating material with 46 to 85% by weight of Al₂O₃, 25 to 54% by weight of SiO₂, a density of 350±10% kg/m³.

Silica sol: Using the mixture by mixing silica sol SS-30 SG (SKemtech), SS-30A (SKemtech), and SS-30 (SKemtech) with SiO₂ particle content of 29 to 31% by weight and SiO₂ particle size of 10 to 20 nm.

Alumina sol: Using alumina sol (Alintech) with Al₂O₃ particle content of 5 to 20% by weight and Al₂O₃ particle size of 20 to 150 nm.

### Water: Distilled Water

Insulating material coating step conditions: After impregnation was performed until no bubbles were generated in the insulating material at a volume ratio of dust-free insulating material coating solution: insulating material=1.5:1 and an impregnation temperature of 20° C., drying was performed at a drying temperature of 200° C. for 1 hour, and coating was performed until the coating amount became 200 kg/m³ (0.20 g/cm³).

Firing step conditions: Firing was performed at a temperature of 1000° C. for 6 hours.

First polishing step conditions: Polishing was performed on the coated insulating material for 10 seconds per surface of the coated insulating material at a speed of 300 rpm using a polishing machine (circular polishing machine) to which #1000 first polishing paper (polishing paper to which aluminum oxide, zirconium silicate, and ceramic particle are applied) was applied.

Second polishing step conditions: Polishing was performed on the coated insulating material for 10 seconds per surface of the coated insulating material at a speed of 300 rpm using a polishing machine (circular polishing machine) to which #3000 second polishing paper (sponge polishing paper type) was applied.

10 dust-free insulating materials were manufactured each by a work method that satisfied the insulating material coating step conditions, the firing step conditions, the first polishing step conditions, and the second polishing step conditions based on the contents of the dust-free insulating material coating solutions described in Table 1 using the insulating material, the silica sol, the alumina sol, and water.

At this time, the coating solution contents in Table 1 below allowed a 1% measurement error, the dust-free insulating material was randomly selected from 10 dust-free insulating materials corresponding to Example 1, the dust-free insulating material was randomly selected from 10 dust-free insulating materials corresponding to Example 2, and the dust-free insulating material was randomly selected from 10 dust-free insulating materials corresponding to Example 3, thereby using them for the test.

TABLE 1

| | Content of dust-free insulating material coating solution | | |
|---|---|---|---|
| Classification | Silica sol (g) | Alumina sol (g) | Water (g) |
| Example1 | 100 | 25 | 50 |
| Example2 | 110 | 22.5 | 42.5 |
| Example3 | 90 | 27.5 | 57.5 |

### Comparative Examples 1 to 3

Insulating material: Using an insulating material with 46 to 85% by weight of Al₂O₃, 25 to 54% by weight of SiO₂, a density of 350±10% kg/m³.

Silica sol: Using the mixture by mixing silica sol SS-30SG (SKemtech), SS-30A (SKemtech), and SS-30 (SKemtech) with SiO₂ particle content of 29 to 31% by weight and SiO₂ particle size of 10 to 20 nm.

Alumina sol: Using alumina sol (Alintech) with Al₂O₃ particle content of 5 to 20% by weight and Al₂O₃ particle size of 20 to 150 nm.

### Water: Distilled Water

Insulating material coating step conditions: After impregnation was performed until no bubbles were generated in the insulating material at a volume ratio of dust-free insulating material coating solution: insulating material=1.5:1 and an impregnation temperature of 20° C., drying was performed at a drying temperature of 200° C. for 1 hour, and coating was performed until the coating amount became 200 kg/m³ (0.20 g/cm³).

Firing step conditions: Firing was performed at a temperature of 1000° C. for 6 hours.

First polishing step conditions: Polishing was performed on the coated insulating material for 10 seconds per surface of the coated insulating material at a speed of 300 rpm using a polishing machine (circular polishing machine) to which #1000 first polishing paper (polishing paper to which aluminum oxide, zirconium silicate, and ceramic particle are applied) was applied.

Second polishing step conditions: Polishing was performed on the coated insulating material for 10 seconds per surface of the coated insulating material at a speed of 300 rpm using a polishing machine (circular polishing machine) to which #3000 second polishing paper (sponge polishing paper type) was applied.

10 dust-free insulating materials were manufactured each by a work method that satisfied the insulating material impregnation step conditions, the firing step conditions, the first polishing step conditions, and the second polishing step conditions based on the contents of the dust-free insulating material coating solutions described in Table 2 using the insulating material, the silica sol, the alumina sol, and water.

At this time, the coating solution contents in Table 2 below allowed a 1% measurement error, the dust-free insulating material was randomly selected from 10 dust-free insulating materials corresponding to Comparative Example 1, the dust-free insulating material was randomly selected from 10 dust-free insulating materials corresponding to Comparative Example 2, and the dust-free insulating material was randomly selected from 10 dust-free insulating materials corresponding to Comparative Example 3, thereby using them for the test.

TABLE 2

| | Content of dust-free insulating material coating solution | | |
|---|---|---|---|
| Classification | Silica sol (g) | Alumina sol (g) | Water (g) |
| Comparative | 100 | 55 | 50 |
| Example 1 | | | |
| Comparative | 100 | 45 | 50 |
| Example 2 | | | |
| Comparative | 100 | 35 | 50 |
| Example 3 | | | |

### Experimental Example 1

In the environment of a temperature of 23±1° C. and a humidity of 31±1% R. H.,

The thermal conductivities (W/mK) according to the temperatures of the uncoated insulating material before coating with the dust-free insulating material coating solution and the dust-free insulating materials according to Examples 1 to 3 were evaluated based on Test Method KS L 1604, and the evaluation results are shown in Table 3.

TABLE 3

| | Uncoated | | | |
|---|---|---|---|---|
| | insulating | | | |
| Classification | material | Example 1 | Example 2 | Example 3 |
| 25° C. | 0.47 | 0.38 | 0.37 | 0.49 |
| 600° C. | 0.66 | 0.56 | 0.59 | 0.64 |
| 800° C. | 0.71 | 0.97 | 0.86 | 1.01 |
| 1,000° C. | 1.12 | 1.14 | 1.10 | 1.18 |

Referring to Table 3, it can be confirmed that the differences in thermal conductivities of the dust-free insulating materials according to Examples 1 to 3 that are embodiments of the present disclosure are not significant compared to the uncoated insulating material before coating with the dust-free insulating material coating solution.

Accordingly, even if the insulating materials are coated with the dust-free insulating material coating solution according to the present disclosure to manufacture the dust-free insulating materials, the dust-free insulating materials can secure the insulation effect and can be applied to the inside of the combustion chamber of the reactor.

### Experimental Example 2

Using the following standard equipment:
Equipment Name: PARTICLE COUNTER
Manufacturer: PMS
Type: LASAIR II—110.

In the environment of a temperature of 23.2±0.1° C. and a humidity of 48±3% R. H., the number of particles was repeatedly measured 20 times at a point 2 mm away from the surface of Example 1 and the number of particles was repeatedly measured 20 times at a point 100 mm away therefrom to obtain averages, and the measurement results are shown in Table 4.

TABLE 4

| | Classification | | | | | |
|---|---|---|---|---|---|---|
| | Example 1 | | Example 2 | | Example 3 | |
| | 20 times average | | 20 times average | | 20 times average | |
| | measurements (pcs) | | measurements (pcs) | | measurements (pcs) | |
| | Point | Point | Point | Point | Point | Point |
| Particle | 2 mm | 100 mm | 2 mm | 100 mm | 2 mm | 100 mm |
| size | away | away | away | away | away | away |
| 0.1 μm | 3.35 | 3.90 | 3.64 | 3.85 | 3.29 | 3.64 |
| 0.2 μm | 1.00 | 1.65 | 1.02 | 1.79 | 0.96 | 1.62 |
| 0.3 μm | 0.10 | 0.20 | 0.12 | 0.23 | 0.09 | 0.18 |
| 0.5 μm | 0.00 | 0.00 | 0.00 | 0.00 | 0.00 | 0.00 |
| 1.0 μm | 0.00 | 0.00 | 0.00 | 0.00 | 0.00 | 0.00 |
| 5.0 μm | 0.00 | 0.00 | 0.00 | 0.00 | 0.00 | 0.00 |

Referring to Table 4, it can be confirmed that the dust-free insulating materials according to Examples 1 to 3 generated less than 10 particles of less than 0.5 μm on average, and did not generate particles of 0.5 μm or more. Accordingly, it can be confirmed that when the insulating materials are manufactured with the dust-free insulating material coating solution according to the present disclosure, dust generation can be suppressed.

### Experimental Example 3

The insulating material before coating with the dust-free insulating material coating solution and the dust-free insulating material according to Example 1 were placed on a black adhesive plate (applied on A4 paper printed with black ink using a general commercial stick-type adhesive), and left on for 1 minute so that they could adhere to the adhesive plate by their own weight.

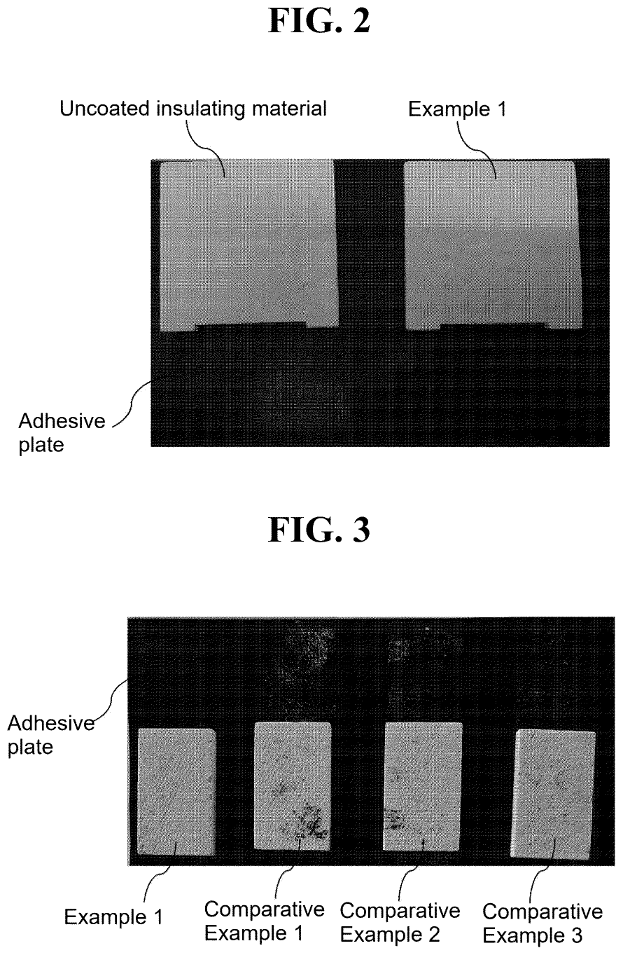

Thereafter, the insulating material and the dust-free insulating material were detached from the adhesive plate to check whether dust was attached to the adhesive plate or not, which is shown in FIG. 2.

Referring to FIG. 2, it can be confirmed that the uncoated insulating material before coating with the dust-free insulating material coating solution has dust attached to the adhesive plate so that the adhesive plate surface of black is stained white.

On the other hand, it can be seen that since dust does not attach to the adhesive plate in Example 1, the adhesive plate is confirmed to be black.

Accordingly, it can be confirmed that when the dust-free insulating material is manufactured by coating the insulating material with the dust-free insulating material coating solution according to the present disclosure, dust generation can be suppressed.

### Experimental Example 4

The dust-free insulating material according to Example 1 and the insulating materials manufactured according to Comparative Examples 1 to 3 were placed on a black adhesive plate (applied on A4 paper printed with black ink using a general commercial stick-type adhesive), and left on for 1 minute so that they could be attached to the adhesive plate by their own weight. Thereafter, the insulating material and the dust-free insulating material were detached from the adhesive plate to check whether dust was attached to the adhesive plate or not, which is shown in FIG. 3.

Referring to FIG. 3, it can be confirmed that dust is attached to the adhesive plate in the dust-free insulating materials according to Comparative Examples 1 to 3 so that the adhesive plate surface of black is stained white.

On the other hand, it can be seen that since dust does not attach to the adhesive plate in Example 1, the adhesive plate is confirmed to be black.

Accordingly, it can be confirmed that when the insulating materials are manufactured with the dust-free insulating material coating solution according to the present disclosure, dust generation can be suppressed.

The specific description of the present disclosure has been made by Examples referring to the attached drawings as described above, but the above-described Examples are only described as preferred examples of the present disclosure, so the present disclosure should not be understood as being limited to Examples above, and the scope of the rights of the present disclosure should be understood by the claims described below and their equivalent concepts.

1. A dust-free insulating material coating solution for manufacturing a dust-free insulating material, which is coated on an insulating material containing silica and alumina, and comprises:
51.4 to 62.9% by weight of a silica sol;
12.9 to 15.7% by weight of an alumina sol; and
a balance of a solvent,
wherein water is applied as the solvent so that environmental problems and safety problems can be prevented during the manufacture of a dust-free insulating material, and an increase in drying and firing time required to completely remove organic solvents and organic materials can be prevented.

2. The dust-free insulating material coating solution of claim 1, wherein the silica sol is a dispersion in which SiO₂ particles are dispersed at a content of 27 to 33% by weight, and the SiO₂ particles has a size of 8 to 25 nm.

3. The dust-free insulating material coating solution of claim 1, wherein the alumina sol is a dispersion in which Al₂O₃ particles are dispersed at a content of 5 to 20% by weight, and the Al₂O₃ particles have a size of 15 to 170 nm.

4. A method for manufacturing a dust-free insulating material, comprising:
an insulating material preparation step of preparing an insulating material containing silica and alumina;
an insulating material coating step of coating the insulating material with a dust-free insulating material coating solution to manufacture a coated insulating material coated with the dust-free insulating material coating solution;
a firing step of heating and firing the coated insulating material;
a first polishing step of polishing the surface of the coated insulating material that has completed the firing step with a first polishing paper; and
a second polishing step of polishing the surface of the coated insulating material that has completed the first polishing step with a second polishing paper.

5. The method of claim 4, wherein the insulating material coating step comprises:
an impregnation step of impregnating the insulating material with a coating solution; and
a drying step of drying the insulating material after completion of the impregnation step, the impregnation step and the drying step being included at least once.
